(19) United States
(12) Patent Application Publication
(10) Pub. No.: US 2010/0204838 A1
(43) Pub. Date: Aug. 12, 2010

(54) ENERGY EFFICIENT AIR CONDITIONING SYSTEM AND METHOD UTILIZING VARIABLE CAPACITY COMPRESSOR AND SENSIBLE HEAT RATIO LOAD MATCHING

(75) Inventors: Frank DiPaolo, Dublin, OH (US); Stephen Sillato, Westerville, OH (US)

Correspondence Address: HARNESS, DICKEY & PIERCE, P.L.C., P.O. BOX 828, BLOOMFIELD HILLS, MI, 48303, US

(73) Assignee: Liebert Corporation, Columbus, OH (US)

(21) Appl. No.: 12/703,836

(22) Filed: Feb. 11, 2010

Related U.S. Application Data
(60) Provisional application No. 61/152,032, filed on Feb. 12, 2009.

(51) Int. Cl. G05B 15/00; F25B 1/00; F01C 1/02; F28D 7/02

(52) U.S. Cl. 700/278; 62/498; 418/55.1; 165/163

(57) ABSTRACT

An air conditioning system that may incorporate a controller, a variable capacity compressor responsive to the controller, an evaporator in communication with an input of the compressor, and at least one cooling component for generating an airflow over the evaporator to generate a cooling airflow using the evaporator, the cooling component being responsive to the controller. A first input enables a user to provide a user determined dry bulb temperature range for an enclosed environment, and a second input enables the user to provide a user determined moisture content range for the enclosed environment. The controller controls at least one of the compressor and the cooling component to vary a sensible heat ratio (SHR), in order to maintain a dry bulb temperature and the moisture content within the enclosed environment in accordance with the user defined ranges.

### CROSS-REFERENCE TO RELATED APPLICATIONS

The present application claims priority to provisional U.S. application Ser. No. 61/151,032, filed Feb. 12, 2009, the disclosure of which is hereby incorporated by reference into the present application.

### FIELD

The present disclosure relates to air conditioning systems, and more particularly to an air conditioning system that makes use of a variable capacity compressor and sensible heat ratio (SHR) load matching to efficiently control an ambient environment within a designated area or room.

### BACKGROUND

The statements in this section merely provide background information related to the present disclosure and may not constitute prior art.

Energy efficiency in an air conditioning system may be accomplished by reducing the system head pressure and system mass flow when available. A compressor with a variable frequency drive (“VFD”) may be used to reduce the system head pressure and system mass flow under certain conditions, and thus provide tangible energy savings. However, a VFD is a relatively costly component. Most air conditioning systems allow the saturated condensing temperature to be limited to a minimum in order to maintain stable system operation. This is especially so for systems employed in geographic areas where the winter time outdoor temperature varies significantly from ambient temperatures during spring and summer months.

Typical HVAC (i.e., heating, ventilation, air conditioning) systems can not satisfy both dry and wet bulb requirements at the same time. If only a dry bulb temperature is monitored to control cooling requirements, then more moisture than desired can be removed from the air. In order to replace the moisture removed it must be replaced, expending additional energy. Similarly, if only a wet bulb temperature is used to satisfy cooling requirements, then over cooling can occur. If overcooling occurs, then energy must be expended to raise the dry bulb temperature back to its original setting.

### SUMMARY

In one aspect the present disclosure relates to an air conditioning system that may include a controller; a variable capacity compressor responsive to the controller; an evaporator in communication with an input of the compressor; and at least one cooling component for generating an airflow over the evaporator to generate a cooling airflow using the evaporator, with the cooling component being responsive to the controller. A first input to the controller enables a user to provide a user determined dry bulb temperature range for an enclosed environment being temperature controlled by the air conditioning system. A second input to the controller enables a user to provide a user selected moisture content. The controller controls at least one of the compressor and the cooling component to vary a sensible heat ratio (SHR) to maintain a dry bulb temperature and the moisture content within the enclosed environment in accordance with the user set ranges.

In another aspect the present disclosure relates to an air conditioning system having an electronic controller and a variable capacity, electronically controlled compressor responsive to the electronic controller. An evaporator is in communication with an input of the compressor. At least one cooling component is used for generating airflow over the evaporator to generate a cooling airflow using the evaporator, with the cooling component being responsive to the electronic controller. A first input to the controller enables a user to provide a user determined dry bulb temperature range for an enclosed environment being temperature controlled by the air conditioning system. A second input to the controller enables the user to provide a user selected moisture content for the enclosed environment. The controller controls an output of the compressor and the cooling component to vary a sensible heat ratio (SHR), to maintain a dry bulb temperature and the moisture content within the enclosed environment in accordance with the user set ranges.

In still another aspect the present disclosure relates to a method for controlling an air conditioning system, where the air conditioning system includes a variable capacity compressor and an evaporative cooling device. The air conditioning system may be used to control cooling of air within an enclosed environment. The method may comprise obtaining a user set dry bulb temperature range and a user set moisture content range to be maintained within the enclosed environment, monitoring a dry bulb temperature of air within the enclosed environment, and monitoring the moisture content within the air in the enclosed environment. At least one of the variable capacity compressor and the evaporative cooling device may be controlled to vary a sensible heat ratio (SHR) of the air conditioning system so as to maintain the dry bulb temperature and the moisture content for the air in the enclosed environment within the user set dry bulb temperature range and the user selected moisture content range, respectively.

The method may include using a controller to receive inputs for a user set dry bulb temperature range and a user set moisture content range to be maintained within the enclosed environment. The controller may be used to monitor both a dry bulb temperature of air, and the moisture content related to the air, within the enclosed environment. The controller may be used to control at least one of the variable capacity compressor and the evaporative cooling device to vary a sensible heat ratio (SHR) of the air conditioning system. The SHR may be controlled to maintain the dry bulb temperature and the moisture content for the air of the enclosed environment within the user set ranges.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of one embodiment of a system in accordance with the present disclosure for controlling the temperature and humidity in a closed environment (although infiltration loads can exist), for example a computer room containing one or more computing devices that generate heat; and

FIG. 2 is a flowchart of operations that may be performed by the system of FIG. 1 in controlling the temperature and humidity in an enclosed environment such as a room.

### DETAILED DESCRIPTION

The following description is merely exemplary in nature and is not intended to limit the present disclosure, application, or uses. It should be understood that throughout the drawings, corresponding reference numerals indicate like or corresponding parts and features.

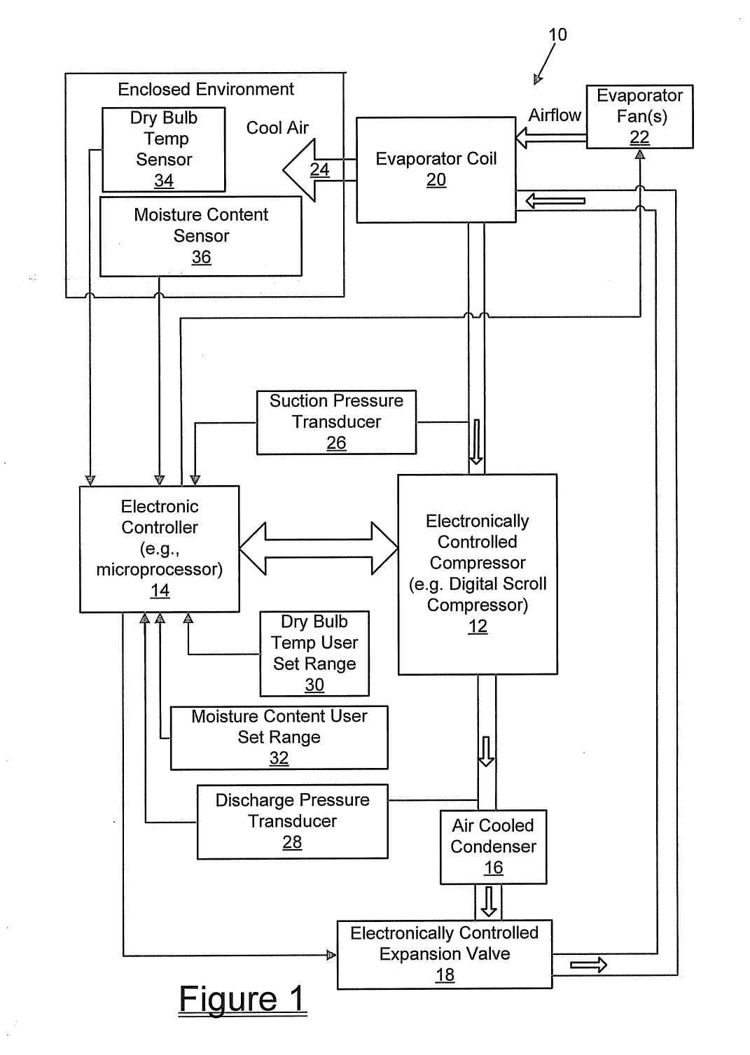

Referring to FIG. 1, there is shown an air conditioning system 10 in accordance with one embodiment of the present disclosure. The system 10 is especially well suited to be used to control the temperature and humidity in closed environments such as rooms and/or buildings where computing equipment, for example file servers, are operating. The system 10 may include a digital scroll compressor 12 (a type of variable capacity compressor) that is electronically controlled by an electronic controller 14. The digital scroll compressor 12 receives a refrigerant and compresses the refrigerant into a hot, compressed gaseous state where it is fed into an air cooled condenser 16. The cooled condenser 16 is located in an outdoor environment and therefore subject to potentially significantly varying ambient temperature conditions over the course of the year, depending on the geographic location where it is located. For example, if the condenser is used at a facility in Minnesota versus Florida, there will be many more hours of colder temperature in Minnesota that results in a reduction in the discharge pressure of the compressor and will thus have a significant effect (i.e., increased cooling effect) on the cooling capability of the system 10

An air cooled condenser 16, typically located in an outdoor environment with the compressor 12, receives the hot refrigerant and condenses it. The condensed refrigerant is fed to an electronically controlled expansion valve 18 that expands the condensed refrigerant and directs the expanded refrigerant to an evaporator 20. Alternatively, any other type of “wide range expansion device” similar to those disclosed in U.S. Pat. No. 5,177,972, incorporated herein by reference, may be employed.

The evaporator 20 may comprise a tube and fin coil evaporator or any other suitable type of evaporator such as one from the class of heat exchangers known in the industry as “microchannel”. One or more electronically controlled cooling devices such as evaporator fans 22 are in heat exchange relationship with the evaporator 20 and generate airflow over the evaporator that produces a cooling airflow 24. The cooling airflow 24 may then be used to cool a controlled environment such as a computer room, or any other room or enclosure where control over temperature and humidity is desired.

The electronic controller 14 is also in communication with the output of a suction pressure transducer 26. The suction pressure transducer 26 is used to monitor the suction pressure of the digital scroll compressor 12. A discharge pressure transducer 28 senses the discharge pressure at the output of the digital scroll compressor 12 and provides a signal representative of same to the electronic controller 14. A dry bulb set temperature range input 30 enables a user to select a desired dry bulb temperature range and provide the input to the electronic controller 14. Similarly, a moisture content set range input 32 allows the user to select a specific moisture content range for the air within the enclosed environment or room that the system 10 is being used to cool. The specific moisture content may be any one of a grains of moisture range, a dew point range or a relative humidity range for the air in the enclosed environment or room.

With further reference to FIG. 1, the electronic controller 14 also receives inputs from a dry bulb temperature sensor 34 that indicates the dry bulb temperature within the enclosed environment. A sensor 36 for measuring the moisture content (i.e., either, dew point or relative humidity) feeds a signal indicative of the sensed moisture content (i.e., dew point or relative humidity) in the air within the enclosed environment to the electronic controller 14. If the selected type of moisture content is a grains of moisture, then it will be appreciated that since the grains of moisture within the enclosed environment cannot be sensed directly, that the electronic controller 14 will use a sensed dew point or a sensed relative humidity within the enclosed environment to assist in calculating the grains of moisture value.

It will be appreciated that increased energy efficiency of the system 10 will result from a reduced outdoor ambient temperature that reduces the system discharge pressure of the digital scroll compressor 12 and allows for increased evaporator 20 capacity. In an application such as the cooling of a computer room, the load seen by the system 10 is nearly constant throughout the year, and thus a mass flow reduction is required to maintain constant capacity of the system 10. Reducing the digital scroll compressor 12 mass flow reduces the compressor power consumption, and thus can result in increased energy efficiency for the system 10.

The system 10 uses the electronic controller 14 to vary the operation of the digital scroll compressor and the evaporator fan 22 to vary the sensible heat ratio (“SHR”) of the system 10. Sensible cooling and latent cooling is driven by the actual unit return air dry bulb temperature sensed by sensor 34 and the moisture content (i.e., dew point or relative humidity) sensed via sensor 36, versus the set points defined via inputs 30 and 32. A relationship for unit SHR is determined from the dew point of the enclosed environment and the evaporator 20 saturated suction temperature. In lieu of a pre-determined unit SHR, a unit SHR may be determined from the inlet and outlet air “dry bulb” temperature and the moisture content (i.e., calculated grains of moisture, dew point or relative humidity). Additionally the evaporator 20 fan speed may be measured along with the compressor 12 suction pressure.

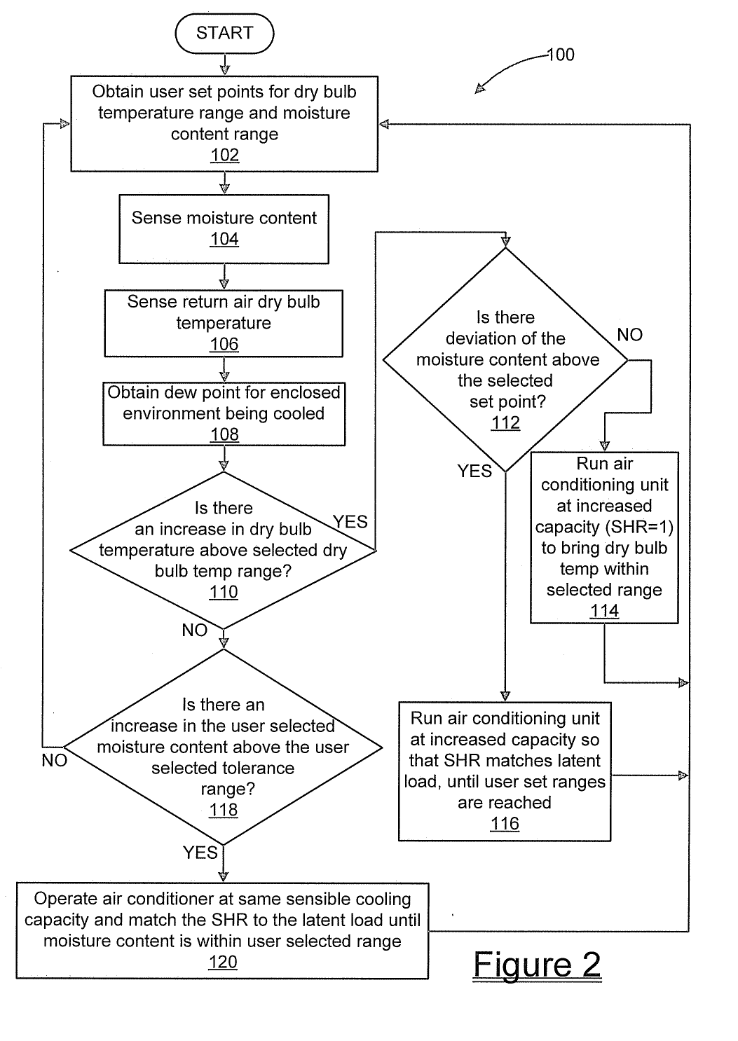

Referring now to the flowchart 100 of FIG. 2, several different scenarios will be described to provide illustrations as to how the digital scroll compressor 12 and the evaporator fans 22 may be controlled in response to differing ambient conditions in the enclosed environment. Initially at operation 102 the user set points are obtained for the desired dry bulb temperature range and the desired moisture content (i.e., desired grains of moisture range, desired dew point range or desired relative humidity range). These are obtained from inputs 30 and 32. At operation 104 the moisture content for the enclosed environment being cooled is obtained using sensor 36. At operation 106 the return air dry bulb temperature is sensed using sensor 34. At operation 108 the dew point for the enclosed environment is obtained.

At operation 110 an inquiry is made if there is an increase in dry bulb temperature above the user selected dry bulb temperature range provided via input 30. If the answer is “Yes”, then an inquiry is made at operation 112 to determine if there is a deviation of the sensed moisture content (i.e., or sensed dew point or sensed relative humidity) via sensor 36, above the user selected set point provided from input 32. If the answer to inquiry 112 is “No”, then the digital scroll compressor 12 and/or the evaporator fans 22 may be operated at increased airflow and increased SHR approaching SHR=1. In other words, the full capacity of the system 10 may be used to remove sensible heat from the room as needed to bring the dry bulb temp of the return air flow within the selected dry bulb temperature range.

If the inquiry at operation 112 produces a “Yes” answer, then the system 10 may be operated at increased capacity so that the SHR matches the latent load, as indicated at operation 116, until the dry bulb temperature and the moisture content (i.e., dew point or relative humidity) sensed in the return air flow are both within the user selected range. This may be accomplished by adjusting the efficiency of the digital scroll compressor 12 and/or the speed of the evaporator fans 22, using signals from the controller 14, as needed to bring the sensed dry bulb temperature and the moisture content (i.e., calculated grains of moisture, sensed dew point or sensed relative humidity) within the user selected ranges.

If the inquiry at operation 110 produces a “No” answer, then an inquiry is made at operation 118 if there has been an increase in the moisture content (i.e., the grains of moisture, or the dew point or the relative humidity) above the user selected tolerance range. If the answer at operation 118 is “Yes”, then the electronic controller 14 controls the digital scroll compressor 12 flow and or the evaporator fans 22 so that the system 10 operates at the same sensible cooling capacity and matches the SHR to the latent load, as indicated at operation 120. This operation is continued until the moisture content (i.e., the dew point or relative humidity) sensed in the return air flow is within the user selected range. The compressor suction pressure is used to enhance the ability of the controller 14 to make decisions on matching the unit SHR to the room latent and sensible load. There is a relationship between the amount of latent cooling and the amount of differential between room dew point and compressor saturated suction temperature. With little or no differential there will be no latent cooling. As the differential increases the amount of latent cooling will increase at fixed evaporator airflow. The compressor discharge pressure measurement is used to control and limit the discharge pressure in order to provide for efficient and stable operation.

The system 10 thus is able to vary the operation of the digital scroll compressor 12 and the evaporator fans 22 to control the SHR as needed to maintain the dry bulb temperature and selected moisture content (i.e., grains of moisture, or dew point or relative humidity) within the enclosed environment within the user selected ranges. The system 10 also takes advantage of the increased evaporator efficiency at low outdoor ambient temperatures by controlling the capacity of the digital scroll compressor 12 and the evaporator fans 22 so that the system 10 achieves maximum energy efficiency.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. An air conditioning system comprising:
a controller;
a variable capacity compressor responsive to the controller;
an evaporator in communication with an input of the compressor;
at least one cooling component for generating an airflow over the evaporator to generate a cooling airflow using the evaporator, the cooling component being responsive to the controller;
a first input for enabling a user to provide a user determined dry bulb temperature range, for an enclosed environment being temperature controlled by the air conditioning system, as an input to the controller;
a second input for enabling a user to provide a user determined moisture content for the enclosed environment as an input to the controller; and
the controller adapted to control at least one of the compressor and the cooling component to vary a sensible heat ratio (SHR), to maintain a dry bulb temperature and a sensed moisture content within the enclosed environment in accordance with the user set dry bulb temperature range and the user set moisture content.

2. The system of claim 1, wherein the user determined moisture content comprises one of a grains of moisture, a dew point and a relative humidity.

3. The system of claim 1, wherein the cooling component comprises an evaporator fan having a speed controlled by the controller.

4. The system of claim 1, further comprising a suction pressure discharge transducer for sensing a suction pressure at an input of the compressor, and providing a signal indicative of the suction pressure to the controller.

5. The system of claim 1, further comprising a discharge pressure transducer for sensing a discharge pressure at an output of the compressor and providing a signal indicative of the discharge pressure to the controller.

6. The system of claim 1, further comprising an air cooled condenser in communication with an output of the compressor for receiving a heated refrigerant from the output of the compressor and condensing the heated refrigerant.

7. The system of claim 6, further comprising an electronically controlled expansion device responsive to the controller for expanding the condensed refrigerant and supplying the expanded, condensed refrigerant to the cooling device.

8. The system of claim 1, wherein the compressor comprises an electronically controlled digital scroll compressor.

9. The system of claim 1, wherein the evaporator comprises a tube and fin coil evaporator.

10. An air conditioning system comprising:
an electronic controller;
a variable capacity, electronically controlled compressor responsive to the electronic controller;
an evaporator in communication with an input of the compressor;
at least one cooling component for generating an airflow over the evaporator to generate a cooling airflow using the evaporator, the cooling component being responsive to the electronic controller;
a first input for enabling a user to provide a user determined dry bulb temperature range, for an enclosed environment being temperature controlled by the air conditioning system, as an input to the electronic controller;
a second input for enabling a user to provide a user set moisture content range for the enclosed environment as an input to the controller; and
the controller adapted to control an output of the compressor and the cooling component to vary a sensible heat ratio (SHR), to maintain a dry bulb temperature and a moisture content within the enclosed environment in accordance with the user set dry bulb temperature range and the user set moisture content range.

11. The system of claim 10, wherein the user set moisture content range comprises one of: a grains of moisture range, a dew point range, and a relative humidity range.

12. The system of claim 10, wherein the cooling component comprises an evaporator fan having a fan speed controlled by the electronic controller.

13. The system of claim 10, wherein the evaporator comprises a tube and fin evaporator coil.

14. The system of claim 10, further comprising a suction pressure transducer in communication with an input of the compressor, the suction pressure transducer providing a signal indicative of a suction pressure of the compressor to the electronic controller.

15. The system of claim 10, further comprising a discharge pressure transducer in communication with an output of the compressor and adapted to provide a signal to the electronic controller representative of the discharge pressure.

16. The system of claim 10, further comprising a condenser for receiving a flow of heated refrigerant from the compressor and condensing the flow of heated refrigerant.

17. The system of claim 16, further comprising an electronically controlled expansion device responsive to an output of the condenser for expanding the flow of heated refrigerant.

18. A method for controlling an air conditioning system including a variable capacity compressor and an evaporative cooling device to control cooling of ambient air within an enclosed environment, the method comprising:
obtaining a user set dry bulb temperature range to be maintained within the enclosed environment;
obtaining a user set moisture content range to be maintained within the enclosed environment;
monitoring a dry bulb temperature of air within the enclosed environment;
monitoring a moisture content within the air in the enclosed environment, in accordance with the user set moisture content; and
controlling at least one of the variable capacity compressor and the evaporative cooling device to vary a sensible heat ratio (SHR) of the air conditioning system so as to maintain the dry bulb temperature and the monitored moisture content for the air in the enclosed environment within the user set dry bulb temperature range and the user selected moisture content range, respectively.

19. The method of claim 18, wherein the user selected moisture content range comprises one of:
a user selected grains of moisture range;
a user selected dew point range; and
a user selected relative humidity range.

20. The method of claim 18, further comprising:
monitoring a suction pressure at an input of the variable capacity compressor and providing a signal indicative of the suction pressure to a controller; and
using the controller to control operation of the variable capacity compressor.

21. The method of claim 18, further comprising monitoring a discharge pressure at an output of the variable capacity compressor and providing an input signal to a controller indicative of the discharge pressure.

22. The method of claim 18, wherein said controlling at least one of the variable capacity compressor and the evaporative cooling device comprises using an electronic controller to control a variable capacity digital scroll compressor and an evaporator fan.

23. The method of claim 18, wherein said controlling at least one of the variable capacity compressor and the evaporative cooling device comprises using an electronic controller to control both of the variable capacity compressor and the evaporative cooling device.
